(19) United States
(12) Patent Application Publication
(10) Pub. No.: US 2003/0219710 A1
(43) Pub. Date: Nov. 27, 2003

(54) Academic knowledge community system and method

(75) Inventors: Lewis Alan Suiter, Denver, CO (US); David Eugene Suiter, Denver, CO (US)

Correspondence Address: MERCHANT & GOULD PC, P.O. BOX 2903, MINNEAPOLIS, MN, 55402-0903, US

(73) Assignee: Academic Knowledge Community LLC

(21) Appl. No.: 10/412,937

(22) Filed: Apr. 11, 2003

Related U.S. Application Data
(60) Provisional application No. 60/372,182, filed on Apr. 11, 2002.

(51) Int. Cl. G09B 3/00

(52) U.S. Cl. 434/350

(57) ABSTRACT

A method and apparatus are provided that provide academic services of an academic institution to members of a knowledge community through an Internet based infrastructure of web pages. According to one aspect, the infrastructure of web pages provides a community center. The community center comprises a plurality of web pages of general interest to all members of the knowledge community. According to another aspect, the infrastructure of web pages provides a plurality of discipline specific knowledge communities. Each of the discipline specific knowledge communities comprises a plurality of web pages of specific interest to members of the knowledge community in targeted disciplines. According to yet another aspect, the infrastructure of web pages provides a plurality of opportunities for a member of the knowledge community to participate in development of the knowledge community. The plurality of opportunities comprises a plurality of web pages through which the member may initiate activities.

This application claims the benefit of U.S. Provisional Application No. 60/372,182, filed Apr. 11, 2002, which is incorporated herein by reference.

### FIELD

The invention relates generally to the field of providing academic services. More particularly, the invention relates to a method and system for marketing and providing academic services of higher education institutions implemented over a network of computers.

### BACKGROUND

Academic institutions have developed systems to meet the needs of the economy of the industrial-era. These industrial-era academic systems prepared students to enter an economy in which traditional factors of production such as natural resources, labor, and capital were the most meaningful resources. The industrial-era academic system is based on an in-out process through which students enter the academic institution at the time of matriculation and leave after graduation. Today, the rise of the information-era economy has made information and knowledge the most meaningful resources. The in-out process of the industrial-era has several flaws that become apparent in the context of an information-era economy.

In the information-era, the need for lifelong learning resources is increasing. Professionals with bachelors and masters degrees are under increasing pressure to demonstrate up-to-date competencies in the rapidly changing global marketplace. Continued access to the academic system after graduation will be important to a graduate's success. Previous, industrial-era academic models do not adequately support graduates once they have left the academic institution. For example, these models typically disconnect graduates from the content-rich information resources and the knowledge relationships they need for professional success.

The industrial-era academic system is also inefficient from the academic institution's point of view. This system downsizes the institution's social and intellectual capital at every graduation ceremony. Additionally, the in-out model dilutes the institution's relationship with thousands of customers whose education needs will continue throughout their careers. In the information-era there is a large market for graduate-level certificate and degree programs. A majority of graduates are likely to return to their respective colleges when pursuing graduate degrees. Therefore, thousands of customers are available to learn about programs and services created especially for their lifelong learning needs by their academic institution. However, industrial-era systems inadequately inform these potential customers of such programs and services.

Finally, the industrial-era system based on an in-out model diminishes the relevance of the academic institution's values in the “real world” by framing those values within the operational box of the in-out model. To increase the relevance of the academic institution's values, communities of shared interests can be created and maintained by the institution. Communities of shared interests are dependent upon giving and voluntary exchange, behaviors that are not congruent with the values of business organizations and transactional relationships. The environment of academic institutions is more conducive to development of these communities. However, the industrial-era academic system does not provide a means to adequately support communities of shared interests.

Therefore, the industrial-era academic system does not adequately address the needs of the information-era. Academic institutions are conversant with technology and have the potential to apply it to the creation of a system that addresses flaws in the industrial-era academic system. An information-era academic system that utilizes technology such as computer networks to support lifelong learning, provide for efficient marketing of the institutions programs and services, and promote the academic institution's values through the creation of communities of shared interests would be useful.

### SUMMARY OF THE INVENTION

A method and apparatus are provided that provide academic services of an academic institution to members of a knowledge community through an Internet based infrastructure of web pages. According to one aspect of the present invention, the infrastructure of web pages provides a community center. The community center comprises a plurality of web pages of general interest to all members of the knowledge community. According to another aspect of the present invention, the infrastructure of web pages provides a plurality of discipline specific knowledge communities. Each of the discipline specific knowledge communities comprises a plurality of web pages of specific interest to members of the knowledge community in targeted disciplines. According to yet another aspect of the present invention, the infrastructure of web pages provides a plurality of opportunities for a member of the knowledge community to participate in development of the knowledge community. The plurality of opportunities comprises a plurality of web pages through which the member may initiate activities.

### BRIEF DESCRIPTION OF THE DRAWINGS

The appended claims set forth the features of embodiments of the invention with particularity. The invention, together with its advantages, may be best understood from the following detailed description taken in conjunction with the accompanying drawings of which:

FIG. 1 is a block diagram conceptually illustrating an exemplary industrial-era academic model;

FIG. 2 is a block diagram conceptually illustrating an academic model according to one embodiment of the present invention;

FIG. 3 is a block diagram illustrating an exemplary computer network over which various embodiments of the present invention may be implemented;

FIG. 4 is a block diagram illustrating groups of web pages for providing academic services to members of a knowledge community according to one embodiment of the present invention;

FIG. 5 is a flowchart illustrating one method for providing academic services to members of a knowledge community according to one embodiment of the present invention;

FIG. 6 is a flowchart illustrating one method for providing a community center to members of a knowledge community according to one embodiment of the present invention;

FIG. 7 is a flowchart illustrating one method for maintaining a member center within a community center according to one embodiment of the present invention;

FIG. 8 is a flowchart illustrating one method for providing a plurality of discipline specific knowledge communities to members of a knowledge community according to one embodiment of the present invention;

FIG. 9 is a flowchart illustrating one method for providing a plurality of opportunities for a member of a knowledge community to participate in development of the knowledge community according to one embodiment of the present invention;

FIG. 10 is a flowchart illustrating one method for generating a new student report according to one embodiment of the present invention;

FIG. 11 is a flowchart illustrating one method for generating a student persistence report according to one embodiment of the present invention;

FIG. 12 is a flowchart illustrating one method for generating a graduate re-enrollment report according to one embodiment of the present invention;

FIG. 13 is a flowchart illustrating one method for generating a graduates' children enrollment report according to one embodiment of the present invention;

FIG. 14 is a flowchart illustrating one method for generating a publication report according to one embodiment of the present invention;

FIG. 15 is a flowchart illustrating one method for generating a service participation report according to one embodiment of the present invention;

FIG. 16 is a flowchart illustrating one method for generating an alumni participation report according to one embodiment of the present invention; and

FIG. 17 is a flowchart illustrating one method for generating an alumni contributions report according to one embodiment of the present invention.

### DETAILED DESCRIPTION

A method and apparatus are described for providing academic services of an academic institution to members of a knowledge community through an Internet based infrastructure of web pages. According to one aspect of the present invention, the infrastructure of web pages provides a community center, a plurality of discipline specific knowledge communities, and a plurality of opportunities for a member of the knowledge community to participate in development of the knowledge community.

In the following description, for the purposes of explanation, numerous specific details are set forth in order to provide a thorough understanding. It will be apparent, however, to one skilled in the art that embodiments of the present invention may be practiced without some of these specific details. In other instances, well-known structures and devices are shown in block diagram form.

Embodiments of the present invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, Compact Disk Read-Only Memories (CD-ROMs), and magneto-optical disks, Read-Only Memories (ROMs), Random Access Memories (RAMs), Erasable Programmable Read-Only Memories (EPROMs), Electronically Erasable Programmable Read-Only Memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

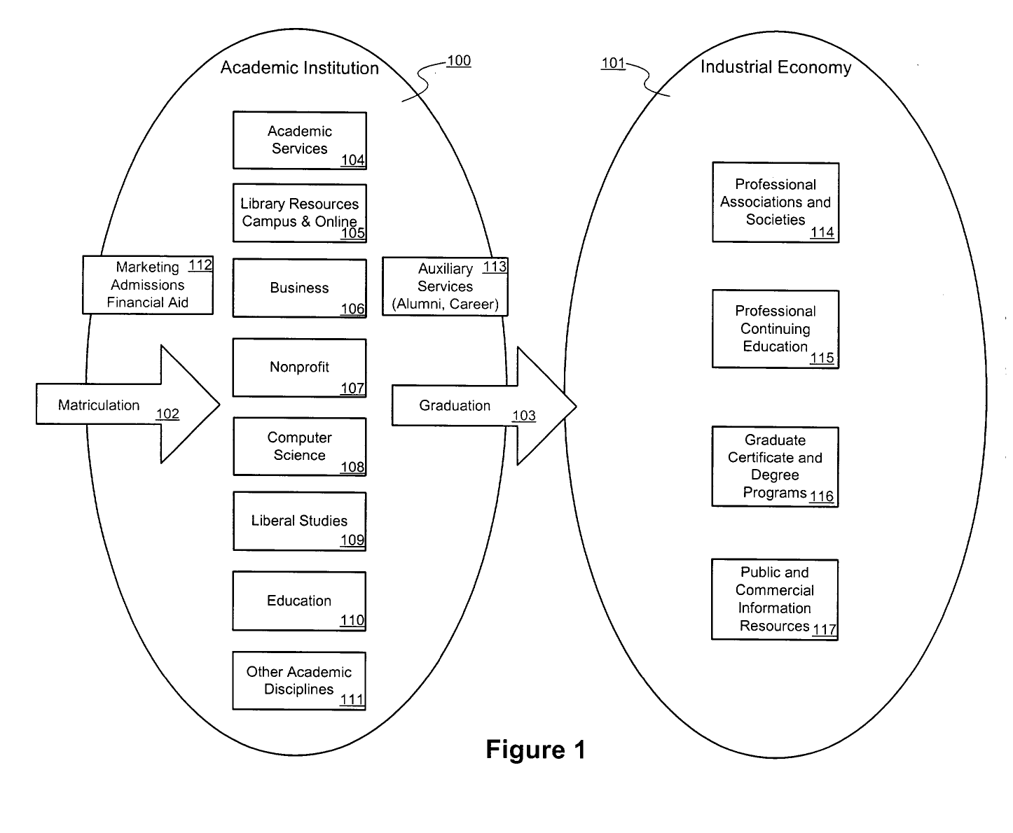

FIG. 1 is a block diagram conceptually illustrating an exemplary industrial-era academic model. This example illustrates academic institution 100 and industrial economy 101. Students enter academic institution 100 at matriculation 102 and leave academic institution 100 at graduation 103 to enter industrial economy 101.

Academic institution 100 consists of various academic and support departments providing a variety of services. For example, marketing, admissions, and financial aid departments 112 advertise the services offered by academic institution 100 and assists students with matriculation 102. Academic services 104 provide additional services to students after entering academic institution 100. For example, academic services 104 may provide mentoring, tutoring, or academic advising services. Library resources 105, both on campus and online, provide students access to information to support in-class learning. Academic institution 100 may provide a wide variety of academic disciplines. For example, certificate or degree programs may be offered in business 106, computer science 108, liberal studies 109, education 110, and other academic disciplines 111. Additionally, academic institution 100 may have a department dedicated to providing nonprofit 107 or charitable services. Normally, academic institution 100 will also have auxiliary services 113 such as career services and alumni services to assist students after graduation 103.

Industrial economy 101 consists of a number of learning opportunities. For example, an individual may have access to professional associations and societies 114, professional continuing education 115, graduate certificate and degree programs 116, and public and commercial information resources 117. These associations, organizations, and other learning opportunities allow an individual to continue the learning process begun in academic institution 100.

However, the industrial-era academic model, as illustrated by FIG. 1, does not adequately address the needs of the information-era. An information-era academic system that utilizes technology such as computer networks to support lifelong learning, provide for efficient marketing of the institutions programs and services, and promote the academic institution's values through the creation of communities of shared interests would be useful.

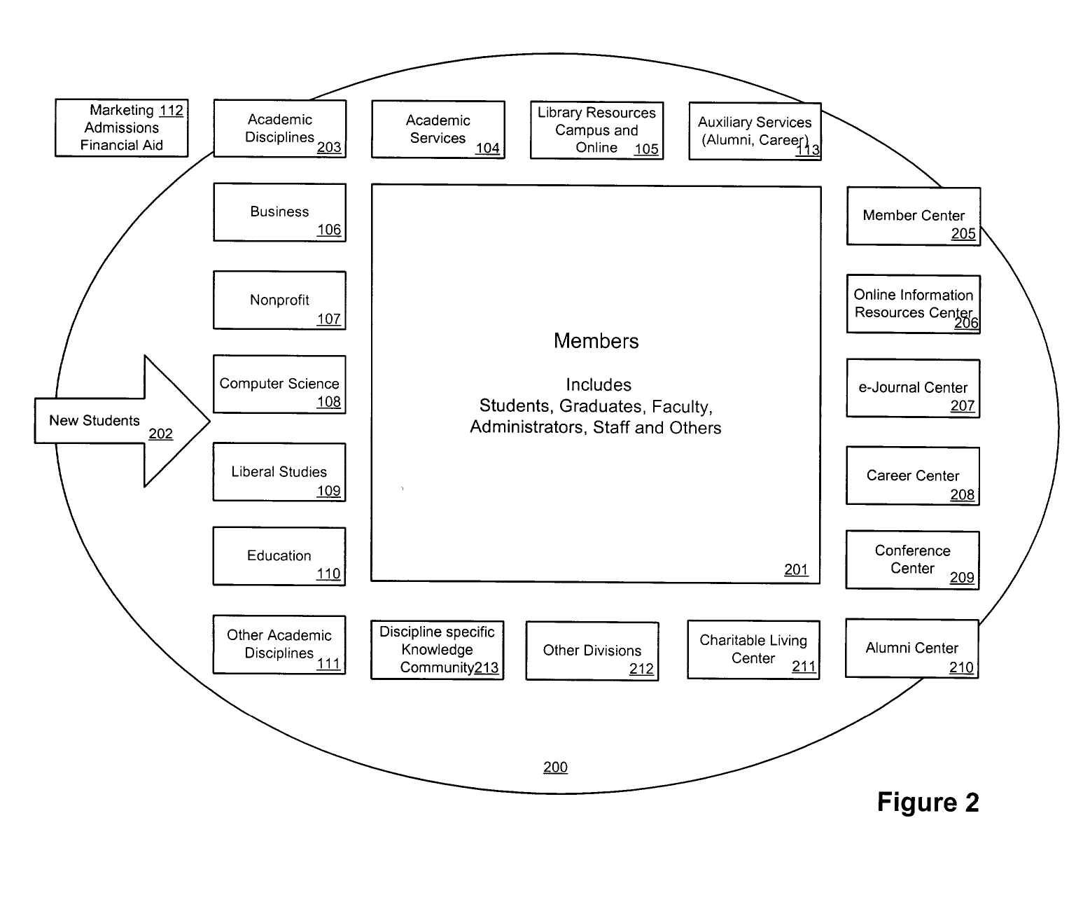

FIG. 2 is a block diagram conceptually illustrating an exemplary academic model according to one embodiment of the present invention. In this model, learning space of the academic institution has been expanded to a knowledge community 200. Members 201 of knowledge community 200 include enrolled students, graduates, faculty, administrators, staff of the academic institution and others.

Knowledge community 200 includes the various academic and support departments of previous academic models. For example, marketing, admissions, and financial aid departments 112 advertise the services offered by academic institution 100 and assists new students 202 entering the academic instituition. Academic services 104 provide additional services to students after entering academic institution 100. For example, academic services 104 may provide mentoring, tutoring, or academic advising services. Library resources 105, both on campus and online, provide students access to information to support in-class learning. Academic institution 100 may provide a wide variety of academic disciplines 203. For example, certificate or degree programs may be offered in business 106, computer science 108, liberal studies 109, education 110, and other academic disciplines 111. Additionally, academic institution 100 may have a department dedicated to providing nonprofit 107 or charitable services. Normally, academic institution 100 will also have auxiliary services 113 such as career services and alumni services to assist students after graduation 103.

According to one embodiment of the present invention, knowledge community 200 includes an Internet-based infrastructure of web pages that place academic programs and services where members 201 can access and interact with those that meet their lifelong learning needs. Knowledge community 200 may, according to one embodiment of the present invention, include member center 205, online information resource center 206, e-Journal center 207, career center 208, conference center 209, alumni center 210, charitable living center 211, representation of other divisions 212, and discipline specific knowledge community 213.

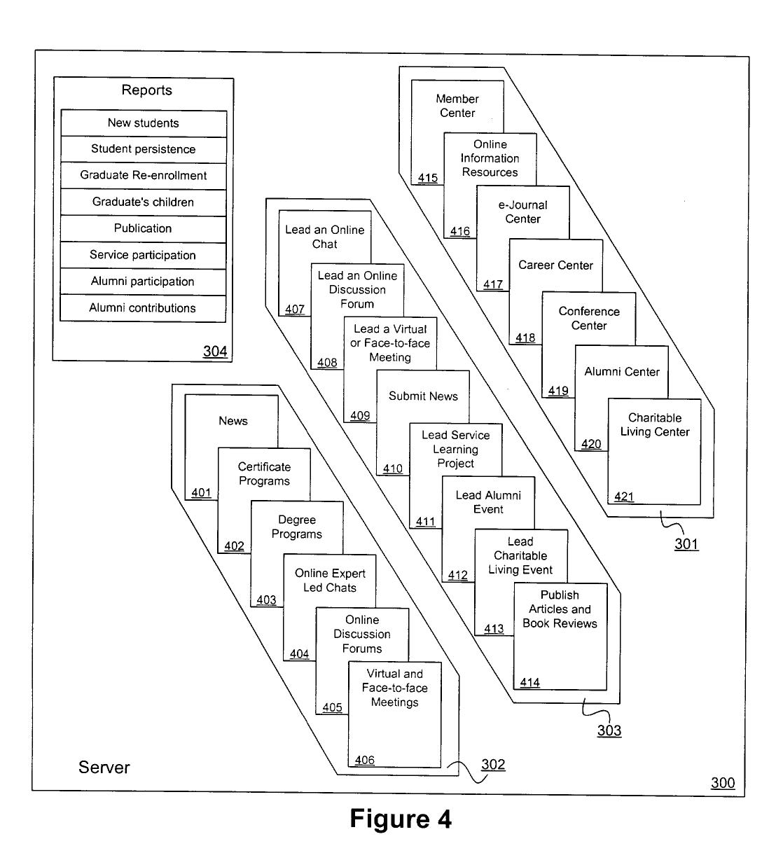

Member center 205, as will be discussed in greater detail below with reference to FIGS. 4-7, represents an Internet-based searchable member database with a member-defined profile that includes academic and professional experience as well as personal interests and preferences. Also included may be member World Wide Web page templates that are completed and maintained by the member.

Online information resource center 206 provides access to content-rich information resources that support life-long learning. According to one embodiment of the present invention, online information resource center 206 comprises a searchable database of articles from trade and academic periodicals. Details of information resource center 206 will be discussed below with reference to FIGS. 4-6.

e-Journal center 207, according to one embodiment of the present invention, comprises an Internet-based searchable database of articles produced by members of the knowledge community. Additional details of e-Journal center 207 will be discussed below with reference to FIGS. 4-6.

According to one embodiment of the present invention, career center 208 comprises Internet-based career center news, searchable job announcements, searchable career oriented online expert led chats, searchable career oriented online discussion forums, and searchable career oriented virtual or face-to-face seminars, workshops, and conferences. Details of career center 208 will be discussed below with reference to FIGS. 4-6.

Conference center 209 facilitates virtual and face-to-face communication and collaboration between members and the academic institution. According to one embodiment of the present invention, conference center 209 comprises news, searchable community and discipline specific online expert led chats and discussion forums, and searchable information regarding community and discipline specific virtual and face-to-face seminars and conferences. Details of conference center 209 will be discussed below with reference to FIGS. 4-6.

According to one embodiment of the present invention, alumni center 210 comprises Internet-based alumni oriented information. The alumni oriented information includes alumni news, searchable alumni online expert led chats, searchable alumni online discussion forums, and searchable alumni virtual or face-to-face seminars, workshops, and conferences. Details of alumni center 210 will be discussed below with reference to FIGS. 4-6.

Charitable living center 211 provides opportunities for charitable giving that are connected to the mission, values, and goals of the knowledge community's members. According to one embodiment of the present invention, charitable living center 211 comprises Internet-based charity oriented information. The charity oriented information may include service learning opportunities, nonprofit job and volunteer opportunities, searchable charity oriented news, searchable charity oriented online expert led chats, searchable charity oriented online discussion forums, and searchable charity oriented virtual or face-to-face seminars, workshops, and conferences. Details charitable living center 211 will be discussed below with reference to FIGS. 4-6.

Through representation of other divisions 212, subdivisions of the academic institution may participate in the knowledge community. For example, various schools or other academic divisions may be represented.

Discipline specific knowledge community 213 provides the structure and information of the knowledge community to small groups of members within a specific discipline such as computer science or business. Details of discipline specific knowledge community 213 will be discussed below with reference to FIGS. 4-5 and 8.

Through the various elements illustrated by FIG. 2, the academic model fosters and supports virtual and face-to-face communication and collaboration between members and the academic institution, relationships within and between academic and professional disciplines, and access to content-rich information resources that support life-long learning. Additionally, this model creates various opportunities for member participation. According to one embodiment of the present invention, these opportunities include: opportunities for faculty and practitioner research, mentoring, and consulting in a collaborative community; opportunities for academic and practitioner contributions to their knowledge community through publication in an internet based e-journal; opportunities for professional growth and personal fulfillment through service learning projects; opportunities for charitable giving that are connected to the mission, values, and goals of the knowledge community's members; and opportunities to recruit new students from among the children of graduates by connecting member families to knowledge community programs and resources.

According to one embodiment of the present invention, the knowledge community is co-produced by its members using an Internet based infrastructure of web pages, searchable databases, chats, and forums, and other interactive technologies, as well as face-to-face communications. Members of the knowledge community may: enter and maintain personal information; create and maintain personal web pages to inform members about themselves and their involvement in the knowledge community; create and lead online chats and forums; create and lead face-to-face seminars, workshops, and conferences; enter and maintain career information, discipline-specific and professional news; create and lead service opportunities; write, review, and publish articles for discipline specific e-journals; create opportunities for and give to charitable projects; access online content rich information resources; and provide continuous feedback on the quality of and changes to knowledge community programs and services.

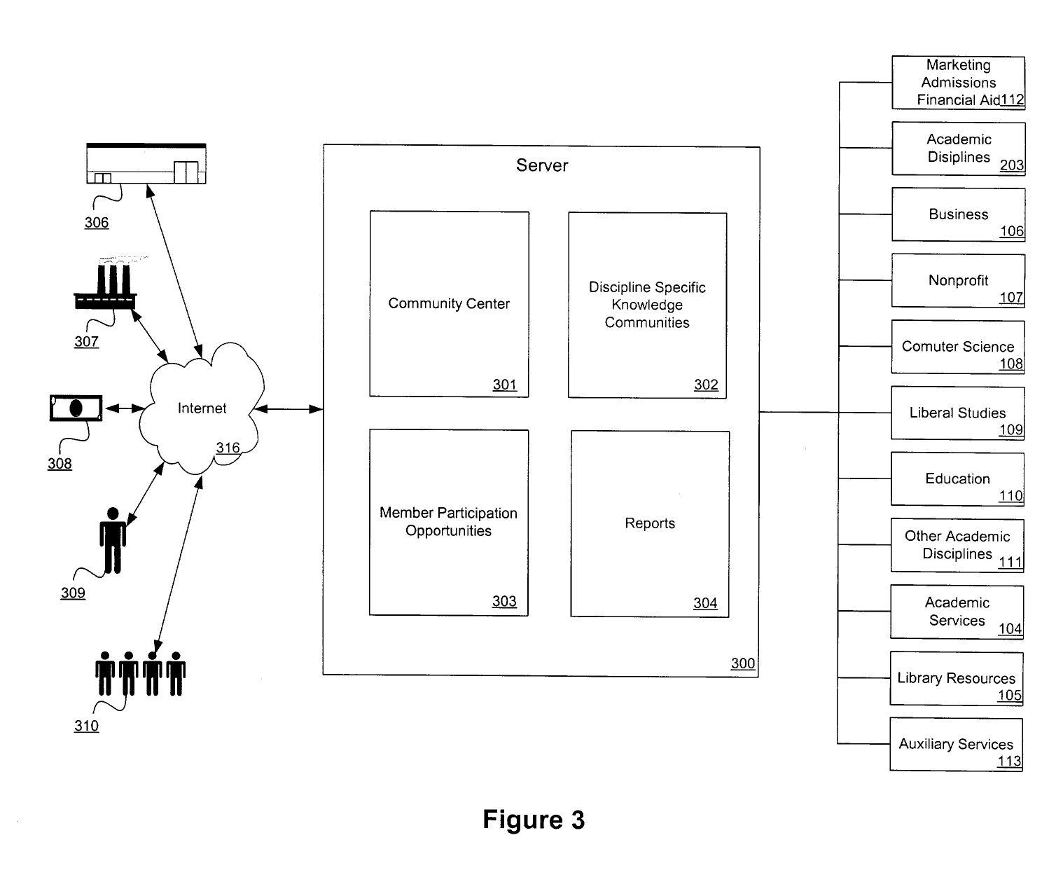

FIG. 3 is a block diagram illustrating an exemplary computer network over which various embodiments of the present invention may be implemented. In this example, the system includes at least one server 300 or other computer capable of supporting multiple users and maintaining databases and other information as will be discussed below. The server 300 maintains a plurality of web pages to provide academic services of an academic institution to members of a knowledge community. The web pages may be divided into three groups, community center 301, discipline specific knowledge communities 302, and member participation opportunities 303.

As will be discussed further below, community center 301, according to one embodiment of the present invention, comprises a plurality of web pages of general interest to all members of the knowledge community. Discipline specific knowledge community 302 may comprise, according to one embodiment of the present invention, a plurality of web pages of specific interest to members of the knowledge community in targeted disciplines. Member participation opportunities, according to one embodiment of the present invention, may comprise a plurality of web pages through which a member may initiate activities to participate in development of the knowledge community.

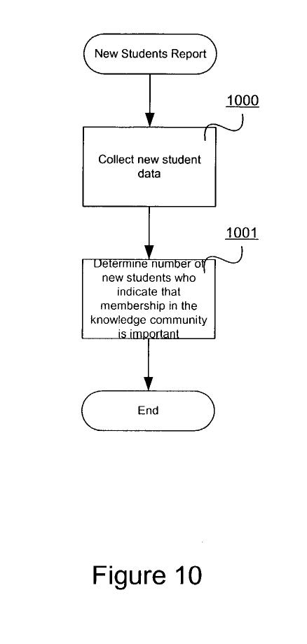

According to another embodiment of the present invention, server 300 may also perform functions for generating reports 304. Reports 304 may be used to track growth of the knowledge community and marketing of the academic services. Details of reports 304 will be discussed below with reference to FIGS. 10-17.

Various departments 104-113 of the academic institution may be connected with server 300. These departments 104-113, as discussed above, include marketing, admissions, and financial aid 112, various academic disciplines 203 such as business 106, computer science 108, liberal studies 109, education 110, and other academic disciplines 111, nonprofit department 107, academic services 104, library resources 105, and auxiliary services 113. Departments 104-113 may be connected with server 300 in a wide variety of ways. For example, the academic institution may operate a Local Area Network (LAN), Wireless Local Area Network (WLAN), Wide Area Network (WAN), or some other type of network through which departments 104-113 may connect with server 300.

Server 300, in the example illustrated by FIG. 3, is also connected with the Internet 305. Via Internet 305 a variety of members 306-310 of the knowledge community may connect with server 300 to access and participate in the knowledge community. Members 306-310 may include but are not limited to businesses 306, industries 307, charitable organizations 308, individuals 309 such as off-campus students, off-campus faculty and staff, alumni, prospective students, or other individuals interested or participating in the knowledge community, and groups 310 including but not limited to professional organizations, trade groups, government agencies, and others.

Therefore, via various networks, including Internet 305, members of the knowledge community may access a series of web pages through which they may interact with the rest of the knowledge community. These web pages may be presented in groups representing a community center 301, a plurality of discipline specific knowledge communities 302, and a plurality of member participation opportunities 303.

FIG. 4 is a block diagram illustrating groups of web pages for providing academic services to members of a knowledge community according to one embodiment of the present invention. This example illustrates server 300 or other computer capable of supporting multiple users and maintaining databases and other information as will be discussed below. Server 300 maintains a plurality of web pages 401-421 representing various aspects of the knowledge community. According to one embodiment of the present invention, web pages 401-421 may be grouped into three categories including a community center 301, one or more discipline specific knowledge communities 302, and member participation opportunities 303. Additionally, server 300 may support functions to generate one or more reports 304. Reports 304 may include but are not limited to a new student report, a student persistence report, a graduate re-enrollment report, a graduates' children enrollment report, a publication report, a service participation report, an alumni participation report, and an alumni contributions report. Each of these reports will be discussed in detail below with reference to FIGS. 10-17.

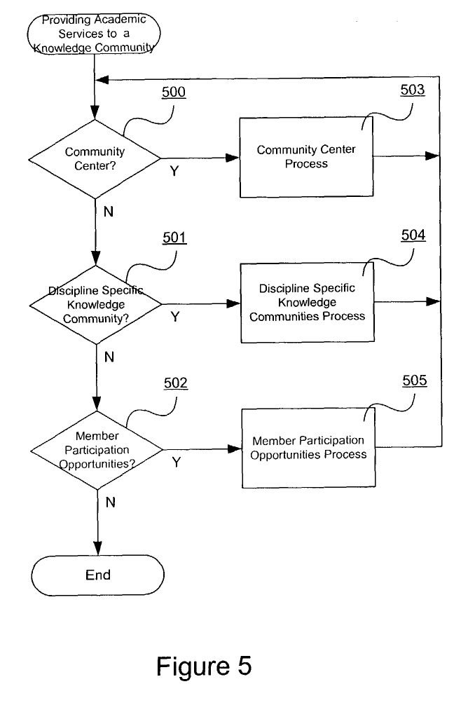

The group of web pages representing community center 301 provide information of general interest to all members of the knowledge community. According to one embodiment of the present invention, community center 301 may include web pages representing member center 415, online information resources 416, e-journal center 417, career center 418, conference center 419, alumni center 420, and charitable living center 421. Details of these pages will be discussed below with reference to FIGS. 5-7.

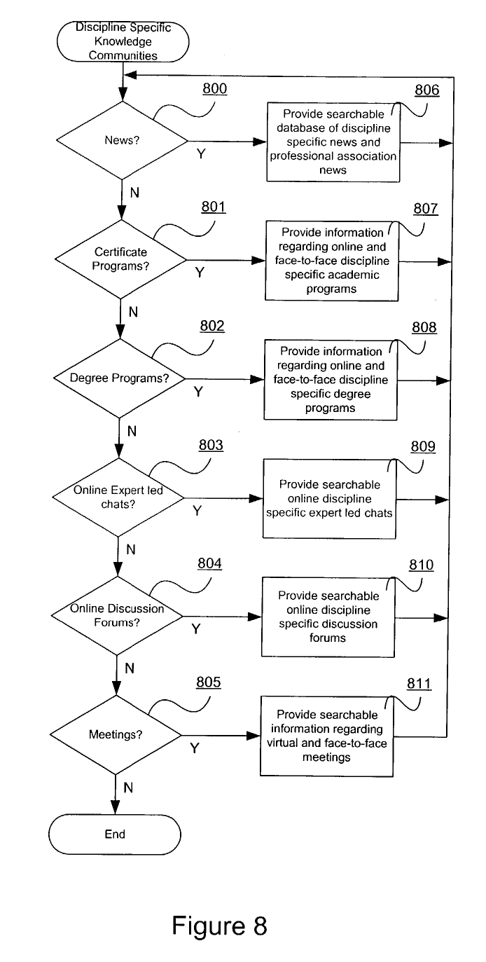

The group of web pages representing discipline specific knowledge communities 302 provide information of specific interest to members of the knowledge community in targeted disciplines. According to one embodiment of the present invention, discipline specific knowledge communities 302 may include web pages representing discipline specific news 401, information about discipline specific certificate programs 402, information about discipline specific degree programs 403, online discipline specific expert led chats 404, online discipline specific discussion forums 405, and discipline specific virtual and face-to-face meetings 406. Details of these pages will be discussed below with reference to FIG. 8.

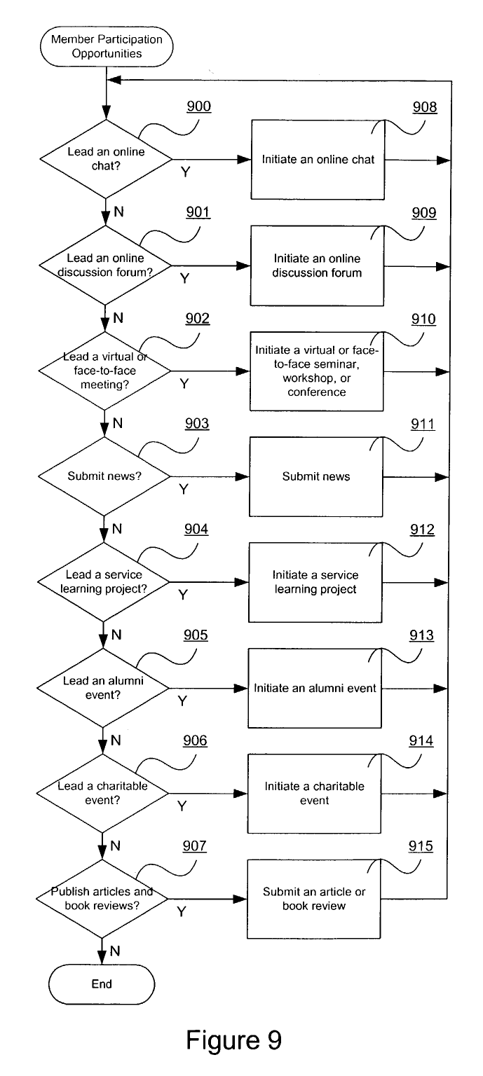

The group of web pages representing member participation opportunities 302 provide web pages through which the member may initiate activities. According to one embodiment of the present invention, member participation opportunities 302 may include web pages representing opportunities to lead a general or discipline specific online chat 407, opportunities to lead a general or discipline specific online discussion forum 408, opportunities to lead a general or discipline specific virtual or face-to-face meeting 409, opportunities to submit general or discipline specific news 410, opportunities to lead a service learning project 411, opportunities to lead an alumni event 412, opportunities to lead a charitable living event 413 and opportunities to publish general or discipline specific articles and book reviews 414. Details of these pages will be discussed below with reference to FIG. 9.

FIG. 5 is a flowchart illustrating one method for providing academic services to members of a knowledge community according to one embodiment of the present invention. This example illustrates a series of decision blocks 500-502 that may represent a series of links on a web page or other similar manner of branching to various options.

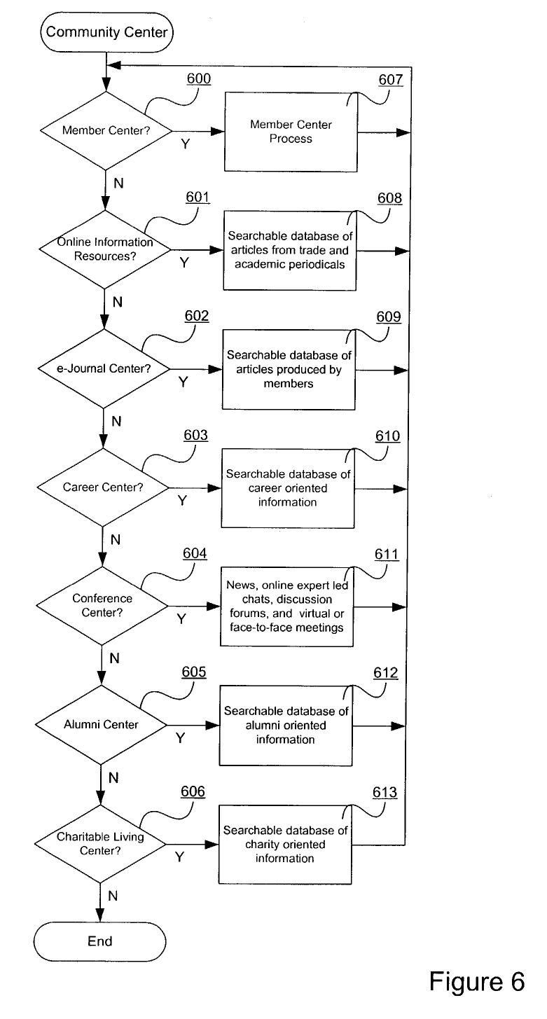

First, at decision block 500, an option is given to branch to a community center. If, at decision block 500 the option is chosen, a community center process is initiated at processing block 503. Community center process 503 may comprise a plurality of web pages of general interest to all members of the knowledge community. Details of community center process 503 will be discussed below with reference to FIG. 6.

Next, at decision block 501, an option is given to branch to a discipline specific knowledge community. If, at decision block 501 the option is chosen, a discipline specific knowledge community process is initiated at processing block 504. Discipline specific knowledge community process 504 may comprise a plurality of web pages of specific interest to members of the knowledge community in targeted disciplines. Details of discipline specific knowledge community process 504 will be discussed below with reference to FIG. 8.

Finally, at decision block 502, an option is given to branch to member participation opportunities. If, at decision block 502 the option is chosen, a member participation opportunities process is initiated at processing block 505. Member participation opportunities process 505 may comprise a plurality of web pages through which the member may initiate activities. Details of community center process 505 will be discussed below with reference to FIG. 9.

FIG. 6 is a flowchart illustrating one method for providing a community center to members of a knowledge community according to one embodiment of the present invention. This example illustrates a series of decision blocks 600-606 that may represent a series of links on a web page or other similar manner of branching to various options.

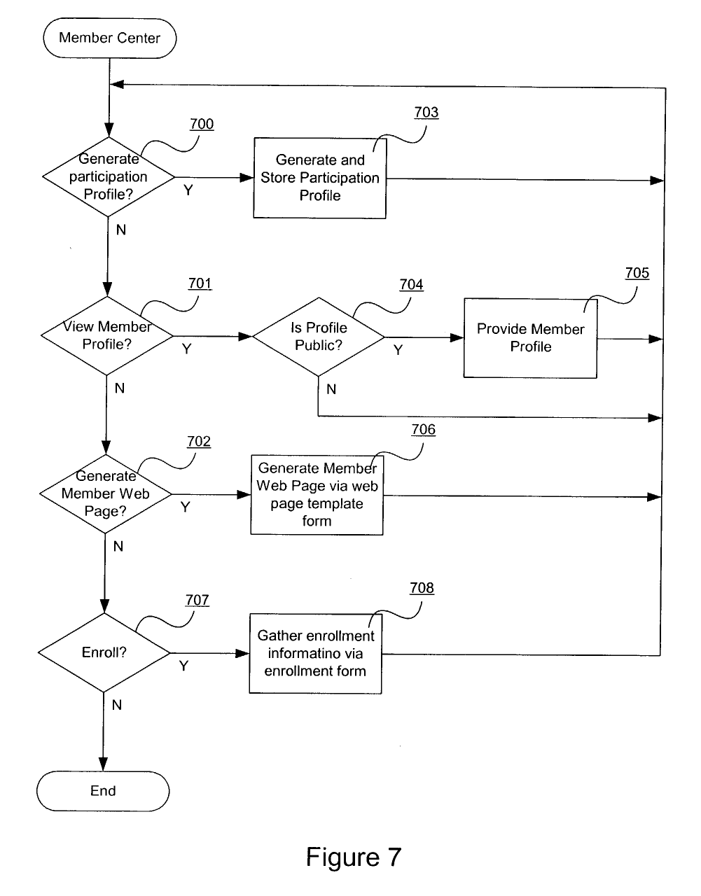

First, at decision block 600 an option is given to branch to a member center. If, at decision block 600 the option is chosen, a member center process is initiated at processing block 607. Member center process 607 may comprise a searchable database of member information. To protect the privacy of members, some aspects of the database may be accessible only by other members of the knowledge community. Details of member center process 607 will be discussed below with reference to FIG. 7.

Next, at decision block 601 an option is given to branch to online information resources. If, at decision block 601 the option is chosen, an online information resources process is initiated at processing block 608. According to one embodiment of the present invention, the online information resource center comprises a searchable database of articles from trade and academic periodicals. An academic institution may work with its library to provide members information that may vary for different disciplines. In some cases this information may be provided on a subscription basis. The institution or members may also develop subject guides for arranging resources.

Since the online information resource center comprises a searchable database of articles, a page may be presented at processing block 608 that allows a member to begin a search or browse through available articles. In some cases, the database may be accessible only by other members of the knowledge community. Alternatively, some or all of the database may be made available to nonmembers.

At decision block 602 an option is given to branch to an e-journal center. If, at decision block 602 the option is chosen, an e-journal center is initiated at processing block 608. According to one embodiment of the present invention, the e-journal center comprises a searchable database of articles produced by members of the knowledge community. Therefore, at processing block 608 a page may be presented that allows a member to begin a search or browse through available articles. In some cases, the database may be accessible only by other members of the knowledge community. Alternatively, some or all of the database may be made available to non-members. According to another embodiment of the present invention, the e-journal center further comprises a web page through which a member may submit an article or book review for review and publication. Submission of an article or book review may be subject to an article submission agreement which may also be available as a web page accessible via a link from the e-journal center.

Next, at decision block 603 an option is given to branch to a career center. If, at decision block 603 the option is chosen, a career center process is initiated at processing block 610. According to one embodiment of the present invention, the career center comprises a searchable database of career oriented information. The career oriented information may comprise career center news, searchable job announcements, searchable career oriented online expert led chats, searchable career oriented online discussion forums, and searchable career oriented virtual or face-to-face seminars, workshops, and conferences. Therefore, at processing block 610 a page may be presented that allows a member to begin a search or browse through available information. In some cases, the database may be accessible only by other members of the knowledge community. Alternatively, some or all of the database may be made available to non-members.

At decision block 604 an option is given to branch to a conference center. If, at decision block 604 the option is chosen, a conference center process is initiated at processing block 611. According to one embodiment of the present invention, the conference center comprises news, searchable online expert led chats, searchable online discussion forums, and searchable information regarding virtual or face-to-face seminars, workshops, and conferences. Therefore, at processing block 611 a page may be presented that allows a member to begin a search or browse through available information. In some cases, the database may be accessible only by other members of the knowledge community. Alternatively, some or all of the database may be made available to non-members.

Next, at decision block 605 an option is given to branch to an alumni center. If, at decision block 605 the option is chosen, an alumni center process is initiated at processing block 612. According to one embodiment of the present invention, the alumni center comprises a searchable database of alumni oriented information. The alumni oriented information may comprise alumni news, searchable alumni online expert led chats, searchable alumni online discussion forums, and searchable information regarding alumni virtual or face-to-face seminars, workshops, and conferences. Therefore, at processing block 612 a page may be presented that allows a member to begin a search or browse through available information. In some cases, the database may be accessible only by other members of the knowledge community. Alternatively, some or all of the database may be made available to non-members.

Finally, at decision block 606 an option is given to branch to a charitable living center. If, at decision block 606 the option is chosen, a charitable living center process is initiated at processing block 613. According to one embodiment of the present invention, the charitable living center comprises a searchable database of charity related information. The charity oriented information may comprise information regarding service learning opportunities, nonprofit job and volunteer opportunities, searchable charity oriented news, searchable charity oriented online expert led chats, searchable charity oriented online discussion forums, and searchable charity oriented virtual or face-to-face seminars, workshops, and conferences. Therefore, at processing block 613 a page may be presented that allows a member to begin a search or browse through available information. In some cases, the database may be accessible only by other members of the knowledge community. Alternatively, some or all of the database may be made available to non-members.

FIG. 7 is a flowchart illustrating one method for maintaining a member center within a community center according to one embodiment of the present invention. This example illustrates a series of decision blocks 700-702 that may represent a series of links on a web page or other similar manner of branching to various options.

First, at decision block 700, an option is given to generate a member participation profile. If, at decision block 700 the member chooses to generate a profile, a member participation profile is generated based on member supplied information and stored in the searchable database of member information. The member information may include academic and professional experience as well as personal interests and preferences. At the time the member participation profile is generated, the member may indicate whether the profile should be made public or private. According to one embodiment of the present invention, the member information may be made private by default and made public only if specified by the member.

At decision block 701 an option is given to view a member participation profile. If, at decision block 701, the member chooses to view a profile, a determination is made at decision block 704 whether the requested profile is public or private. If the profile is determined to be public at decision block 704 the requested member participation profile is provided at processing block 705.

Next, at decision block 702, an option is given to generate a member web page. If, at decision block 702, the member chooses to generate a web page, a member web page template form is presented at processing block 706 to collect information from the member and a page is generated based on this information. According to one embodiment of the present invention, the member web page may be used to share personal and professional information with other members. Therefore, the member web page template form may collect information and digital photographs regarding a members personal interests, professional background, knowledge community participation, etc.

At decision block 707 an option may also be given to enroll in the knowledge community. If, at decision block 707, the user chooses to enroll, an enrollment form page is presented at processing block 708 to collect information and enroll the user. If a fee is charged for participation in the knowledge community, arrangements for paying the fee may also be made through the enrollment form page.

FIG. 8 is a flowchart illustrating one method for providing a plurality of discipline specific knowledge communities to members of a knowledge community according to one embodiment of the present invention. This example illustrates a series of decision blocks 800-805 that may represent a series of links on a web page or other similar manner of branching to various options.

First, at decision block 800, an option is given to branch to discipline specific news. If, at decision block 800, the member chooses to view discipline specific news, discipline specific news is presented at processing block 607. According to one embodiment of the present invention, the discipline specific news may comprise a searchable database of news and professional association news. Therefore, at processing block 806 a page may be presented that allows a member to begin a search or browse through available information. In some cases, the database may be accessible only by other members of the knowledge community. Alternatively, some or all of the database may be made available to non-members.

Next, at decision block 801, an option is given to branch to information regarding discipline specific certificate programs. If, at decision block 801, the member chooses the option, information regarding discipline specific certificate programs is provided at processing block 807. According to one embodiment of the present invention, the information regarding discipline specific certificate programs comprises searchable information regarding online and face-to-face discipline specific academic certificate programs. Therefore, at processing block 807 a page may be presented that allows a member to begin a search or browse through available information such as schedules and course descriptions.

At decision block 802 an option is given to branch to information regarding discipline specific degree programs. If, at decision block 802, the member chooses to view information regarding discipline specific degree programs, information regarding discipline specific degree programs is provided at processing block 808. According to one embodiment of the present invention, the information regarding discipline specific degree programs comprises searchable information regarding online and face-to-face discipline specific academic degree programs. Therefore, at processing block 808 a page may be presented that allows a member to begin a search or browse through available information such as schedules and course descriptions.

Next, at decision block 803, an option is given to branch to online discipline specific expert led chats. If, at decision block 803, the option is chosen, expert led chats are presented at processing block 809. According to one embodiment of the present invention, the information regarding online discipline specific expert led chats is searchable. Therefore, at processing block 809 a page may be presented that allows a member to begin a search or browse through available information. In some cases, the information may be accessible only by other members of the knowledge community. Alternatively, some or all of the information may be made available to non-members.

At decision block 804 an option is given to branch to online discipline specific discussion forums. If, at decision block 804, the member chooses discipline specific discussion forums, discussion forums are presented at processing block 810. According to one embodiment of the present invention, the online discipline specific discussion forums are searchable. Therefore, at processing block 810 a page may be presented that allows a member to begin a search or browse through available information. In some cases, the information may be accessible only by other members of the knowledge community. Alternatively, some or all of the information may be made available to non-members.

Finally, at decision block 805, an option is given to branch to information regarding discipline specific meetings. If, at decision block 805, the option is chosen, information regarding discipline specific meetings is provided at processing block 811. According to one embodiment of the present invention, the information regarding discipline specific meetings comprises a searchable database of information regarding virtual and face-to-face meetings. The virtual and face-to-face meetings may be seminars, workshops, conferences, etc. Therefore, at processing block 811 a page may be presented that allows a member to begin a search or browse through available information.

FIG. 9 is a flowchart illustrating one method for providing a plurality of opportunities for a member of a knowledge community to participate in development of the knowledge community according to one embodiment of the present invention. This example illustrates a series of decision blocks 900-907 that may represent a series of links on a web page or other similar manner of branching to various options.

First, at decision block 900, an option is given to lead a general or discipline specific online chat. If, at decision block 900, the member chooses to lead a general or discipline specific online chat, an online chat may be initiated at processing block 908. However, prior to initiation of the online chat, some approval process may be performed. For example, a check could be made to verify that the person wishing to lead an online chat is actually a member of the knowledge community, that the member is authorized to lead an online chat, and that the member is qualified to assume such a role. Additionally, approval of the topic and content of the online chat may be requested. Therefore, processing block 908 may alternatively provide an application form for the member to complete and/or perform a check of member records before approval and initiation of the online chat.

Next, at decision block 901, an option is given to lead a general or discipline specific online discussion forum. If, at decision block 901, the member chooses to lead a general or discipline specific online discussion forum, an online discussion forum may be initiated at processing block 909. However, prior to initiation of the online discussion forum, some approval process may be required. For example, a check could be made to verify that the person wishing to lead an online discussion forum is actually a member of the knowledge community, that the member is authorized to lead an online discussion forum, and that the member is qualified to assume such a role. Additionally, approval of the topic and content of the online discussion forum may be requested. Therefore, processing block 909 may alternatively provide an application form for the member to complete and/or perform a check of member records before approval and initiation of the online discussion forum.

At decision block 902 an option is given to lead a virtual or face-to-face meeting. If, at decision block 902, the option is chosen, a meeting may initiated at processing block 910. The meeting may be a virtual or face-to-face seminar, workshop, conference, etc. However, prior to initiation of the meeting, some approval process may be required. For example, a check could be made to verify that the person wishing to lead a meeting is actually a member of the knowledge community, that the member is authorized to lead a meeting, and that the member is qualified to assume such a role. Additionally, approval of the topic and agenda of the meeting may be requested. Therefore, processing block 910 may alternatively provide an application form for the member to complete and/or perform a check of member records before approval and initiation of the meeting.

Next, at decision block 903, an option is given to submit general or discipline specific news. If, at decision block 903, the member chooses to submit general or discipline specific news, the member may submit general or discipline specific news at processing block 911. However, prior to accepting the news, some approval process may be required. For example, a check could be made to verify that the person wishing to submit news is actually a member of the knowledge community and that the member is authorized to submit news. Additionally, approval of the topic and content of the news may be requested. Therefore, processing block 911 may also provide an application form for the member to complete and/or perform a check of member records before approval and posting of the news.

At decision block 904 an option is given to lead a service learning project. If, at decision block 904, the option is chosen, a service learning project may be initiated at processing block 912. However, prior to initiation of the service learning project, some approval process may be required. For example, a check could be made to verify that the person wishing to lead a service learning project is actually a member of the knowledge community, that the member is authorized to lead a a service learning project, and that the member is qualified to assume such a role. Additionally, approval of the goals and activities of the service learning project may be requested. Therefore, processing block 912 may alternatively provide an application form for the member to complete and/or perform a check of member records before approval and initiation of the service learning project.

Next, at decision block 905 an option is given to lead an alumni event. If, at decision block 905, the member chooses to lead an alumni event, an alumni event may be initiated at processing block 913. However, prior to initiation of the alumni event, some approval process may be required. For example, a check could be made to verify that the person wishing to lead an alumni event is actually a member of the knowledge community, that the member is actual an alum, that the member is authorized to lead an alumni event, and that the member is qualified to assume such a role. Additionally, approval of the nature of the alumni event may be requested. Therefore, processing block 913 may alternatively provide an application form for the member to complete and/or perform a check of member records before approval and initiation of the alumni event.

At decision block 906 an option is given to lead a charitable event. If, at decision block 906, the member chooses to lead a charitable event, a charitable event may initiated at processing block 914. However, prior to initiation of the charitable event, some approval process may be required. For example, a check could be made to verify that the person wishing to lead a charitable event is actually a member of the knowledge community, that the member is authorized to lead a charitable event, and that the member is qualified to assume such a role. Additionally, approval of the nature of the charitable event may be requested. Therefore, processing block 914 may alternatively provide an application form for the member to complete and/or perform a check of member records before approval and initiation of the charitable event.

Finally, at decision block 907 an option is given to publish general or discipline specific articles or book reviews. If, at decision block 907, the option is chosen, the member may submit the article or book review at processing block 915. However, prior to publication of the article or book review, some approval process may be required. For example, a check could be made to verify that the person wishing to publish an article is actually a member of the knowledge community and that the member is authorized to publish an article. Therefore, processing block 915 may alternatively provide an application form for the member to complete and/or perform a check of member records before approval and publication of the article or book review. Additionally, the article may be reviewed by an editor or editorial board prior to publication.

As introduced above, in order to track growth of the knowledge community and marketing of the academic services, reports may be generated based on a number of criteria. For example, reports may be made to track new student enrollment, student persistence to graduation, graduate re-enrollment, number of graduates' children enrolled, amount of publications, service participation, alumni participation, and alumni contributions. Each of these reports will be discussed in detail below with reference to FIGS. 10-17.

One goal of the academic institution may be to attract new students. Therefore, a report tracking the number of new students who indicate that membership in the knowledge community is important to their choice of the academic program may be useful to the institution. FIG. 10 is a flowchart illustrating one method for generating a new student report according to one embodiment of the present invention. In this example, information is collected for all new students at processing block 1000. To collect this information, the enrollment application may include a question for the student to answer indicating the importance he places on being a member of the knowledge community. Alternatively, the students may be polled in another way.

Next, at processing block 1001 a determination is made based on the student data indicating a number of new students who indicate that membership in the knowledge community is important to their choice of the academic institution. The office of admissions may record and report this information monthly, annually, or on some other schedule.

Another goal of the academic institution may be to increase student persistence to graduation. Therefore, the institution may wish to have a report indicating a change the in rate of student persistence to graduation above a base-line rate established prior to implementation of the knowledge community. That is, the report may indicate a rate of student persistence to graduation relative to a base-line rate established prior to implementation of the knowledge community.

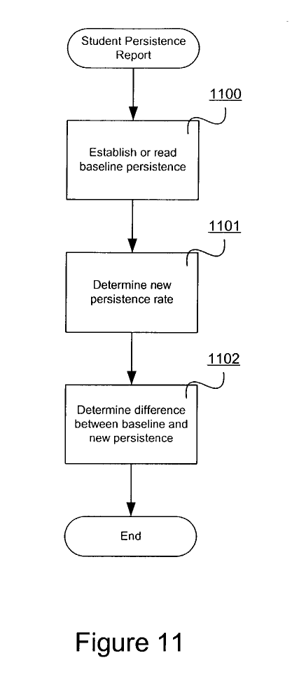

FIG. 11 is a flowchart illustrating one method for generating a student persistence report according to one embodiment of the present invention. First, at processing block 1100 a base-line rate is established for each school, department, or program. The baseline rate is the average percentage rate for persistence to graduation for some period prior to implementation to the knowledge community. Next, at processing block 1101, a new persistence rate is determined. Finally, at processing block 1102, a difference between the baseline and new persistence rates is determined. The Office of the Registrar may report this information annually, semi-annually, quarterly or on another schedule.

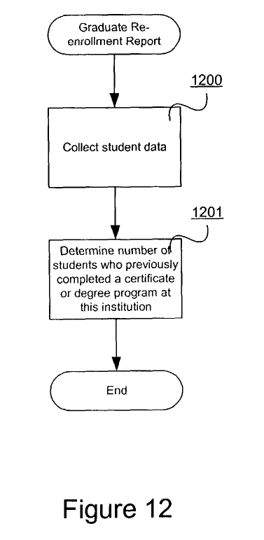

Yet another goal of the academic institution may be to increase graduate re-enrollment. That is, the institution may wish to increase the number of students who previously completed a certificate of degree program offered by the academic institution and re-enroll in another certificate or degree program. FIG. 12 is a flowchart illustrating one method for generating a graduate re-enrollment report according to one embodiment of the present invention. In this example, student information is collected at processing block 1200. This process may consist of polling students through questions on an enrollment application. Alternatively, the information may be generated by the academic institution based on academic records. Next, at processing block 1201 the number of students who previously completed a certificate or degree program offered by the academic institution and re-enroll in a certificate or degree program offered by the academic institution is determined. Such a report may be generated by the office of admissions or registrar and reported annually or on another schedule.

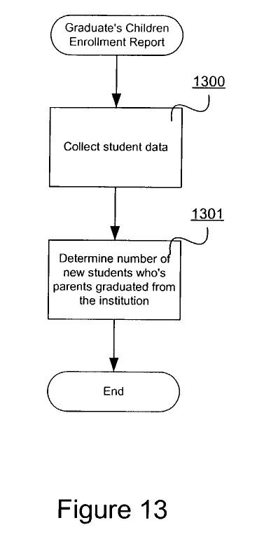

An academic institution may also wish to increase enrollment of graduates' children. That is, the institution may wish to track the number of new students who enroll in a certificate or degree program who indicate that his or her parent or guardian graduated from the academic institution. FIG. 13 is a flowchart illustrating one method for generating a graduates' children enrollment report according to one embodiment of the present invention. In this example, student data is collected at processing block 1300. This information may be self-reported by students through question on an enrollment form or generated by the academic institution based on academic records. Next, at processing block 1301, a determination is made of a number of new students who enroll in a certificate or degree program offered by the academic institution, wherein the new students' parents graduated from the academic institution. This report may be generated by the office of admissions or registrar may be reported annually or on another schedule.

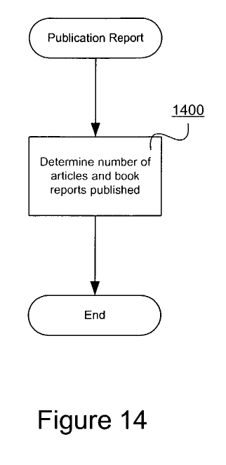

Another goal of the academic institution may be to increase publication by its faculty, staff, and other members of the knowledge community. Therefore, the institution may wish to track the number of member articles and book reviews accepted and published in a knowledge community e-journal. FIG. 14 is a flowchart illustrating one method for generating a publication report according to one embodiment of the present invention. In this example, a determination is made at processing block 1400 of the total number of articles published by members. This determination may be made by the editor of the e-journal and reported annually or on another schedule.

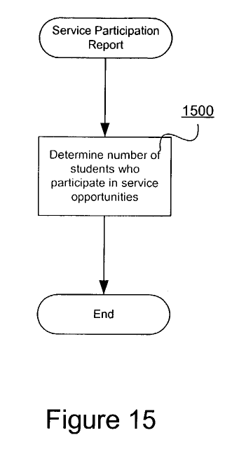

The academic institution may wish to increase participation of members in service opportunities such as participating in service learning programs, serving as nonprofit volunteers, or co-producing new charitable projects. FIG. 15 is a flowchart illustrating one method for generating a service participation report according to one embodiment of the present invention. At processing block 1500 a determination is made of the total number of members who participate in service opportunities. This number may be determined by polling members or other means. The report may be generated by applicable administrators and reported annually or on another schedule.

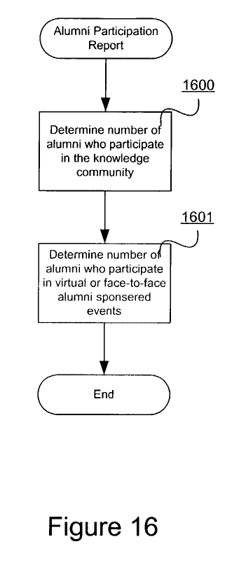

Another goal of the academic institution may be to increase alumni participation in various events. That is, the institution may wish to determine the number of alumni who enroll in the knowledge community and the number who co-produce virtual or face-to-face alumni sponsored events. FIG. 16 is a flowchart illustrating one method for generating an alumni participation report according to one embodiment of the present invention. First, at processing block 1600, a determination is made of the total number of alumni who participate in the knowledge community or the percentage of total alumni enrolled in the knowledge community. This determination may be based on polling alumni, knowledge community enrollment records, or other means. Next, at processing block 1601, a determination is made of the number of alumni who participate in virtual or face-to-face alumni sponsored events. This determination may be based on polling of alumni or other means. This report may be generated by an alumni office and reported annually or on another schedule.

Finally, an academic institution may wish to increase alumni giving. That is, the institution may set a goal of increasing the number of new member donors and the total dollar amount of charitable gifts to or through the academic institution. New member donors may be considered members who have not contributed to or through the institution prior to the implementation of the knowledge community.

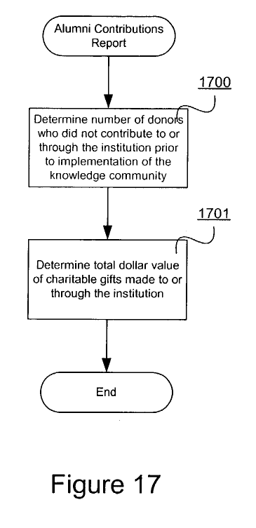

FIG. 17 is a flowchart illustrating one method for generating an alumni contributions report according to one embodiment of the present invention. First, at processing block 1700 a determination is made of the number of current donors who did not contribute to or through the academic institution prior to implementation of the knowledge community. Next, at processing block 1701 a determination is made of the total dollar value of charitable gifts made to or through the academic institution. This report may be generated by an office of development and reported annually or on another schedule.

Various embodiments disclosed herein provide for methods and systems that provide academic services of an academic institution to members of a knowledge community through an Internet based infrastructure of web pages. According to one aspect of the present invention, the infrastructure of web pages provides a community center, a plurality of discipline specific knowledge communities, and a plurality of opportunities for a member of the knowledge community to participate in development of the knowledge community. The knowledge community thereby enables administrators to deliver products and/or services to its customers (i.e. members), enables administrators to monitor and report member participation, facilitates direct communication between members and the academic institution, and fosters the co-production and retention of social and intellectual capital through information resource and interactive relationships, virtual and face-to-face.

What is claimed is:

1. A method providing academic services of an academic institution to members of a knowledge community through an Internet based infrastructure of web pages, the method comprising:
providing a community center, the community center comprising a plurality of web pages of general interest to all members of the knowledge community;
providing a plurality of discipline specific knowledge communities, each of the discipline specific knowledge communities comprising a plurality of web pages of specific interest to members of the knowledge community in targeted disciplines; and
providing a plurality of opportunities for a member of the knowledge community to participate in development of the knowledge community, the plurality of opportunities comprising a plurality of web pages through which the member may initiate activities.

2. The method of claim 1, wherein providing a community center comprises maintaining a member center, the member center comprising a searchable database of member information, the database accessible only by other members of the knowledge community.

3. The method of claim 2, wherein maintaining a member center further comprises enrolling new members via an enrollment form page.

4. The method of claim 2, wherein maintaining a member center further comprises:
generating a member participation profile based on member supplied information;
storing the member participation profile in the searchable database of member information; and
providing the member participation profile to other members of the knowledge community if the member supplied information indicates that the member participation profile is public information.

5. The method of claim 2, wherein maintaining a member center further comprises generating a member web page based on information provided by the member via a member web page template form.

6. The method of claim 1, wherein providing a community center comprises maintaining an online information resource center, the online information resource center comprising a searchable database of articles from trade and academic periodicals, the database accessible only by other members of the knowledge community.

7. The method of claim 1, wherein providing a community center comprises maintaining an electronic journal (e-journal) center, the e-journal center comprising a searchable database of articles produced by members of the knowledge community, the database accessible only by other members of the knowledge community.

8. The method of claim 7, wherein the e-journal center further comprises a web page through which a member may submit an article or book review.

9. The method of claim 1, wherein providing a community center comprises maintaining a career center of career oriented information, career oriented information comprising career center news, searchable job announcements, searchable career oriented online expert led chats, searchable career oriented online discussion forums, and searchable information regarding career oriented virtual or face-to-face seminars, workshops, and conferences.

10. The method of claim 1, wherein providing a community center comprises maintaining a conference center, the conference center comprising news, searchable online expert led chats, searchable online discussion forums, and searchable information regarding virtual or face-to-face seminars, workshops, and conferences.

11. The method of claim 1, wherein providing a community center comprises maintaining an alumni center of alumni oriented information, the alumni oriented information comprising alumni news, searchable alumni online expert led chats, searchable alumni online discussion forums, and searchable information regarding alumni oriented virtual or face-to-face seminars, workshops, and conferences.

12. The method of claim 1, wherein providing a community center comprises maintaining a charitable living center of charity oriented information, the charity oriented information comprising service learning opportunities, nonprofit job and volunteer opportunities, searchable charity oriented news, searchable charity oriented online expert led chats, searchable charity oriented online discussion forums, and searchable information regarding charity oriented virtual or face-to-face seminars, workshops, and conferences.

13. The method of claim 1, wherein providing a plurality of discipline specific knowledge communities comprises providing discipline specific news, the discipline specific news comprising a searchable database of news and professional association news.

14. The method of claim 1, wherein providing a plurality of discipline specific knowledge communities comprises providing information regarding online and face-to-face discipline specific academic certificate programs.

15. The method of claim 1, wherein providing a plurality of discipline specific knowledge communities comprises providing information regarding online and face-to-face discipline specific academic degree programs.

16. The method of claim 1, wherein providing a plurality of discipline specific knowledge communities comprises providing searchable online discipline specific expert led chats.

17. The method of claim 1, wherein providing a plurality of discipline specific knowledge communities comprises providing searchable online discipline specific discussion forums.

18. The method of claim 1, wherein providing a plurality of discipline specific knowledge communities comprises providing searchable information regarding virtual and face-to-face meetings.

19. The method of claim 1, wherein providing a plurality of opportunities for members to participate in development of the knowledge community comprises providing an opportunity to lead a virtual or face-to-face meeting.

20. The method of claim 1, wherein providing a plurality of opportunities for members to participate in development of the knowledge community comprises providing an opportunity to lead an expert led online chat.

21. The method of claim 1, wherein providing a plurality of opportunities for members to participate in development of the knowledge community comprises providing an opportunity to lead an online discussion forum.

22. The method of claim 1, wherein providing a plurality of opportunities for members to participate in development of the knowledge community comprises provide an opportunity to submit news.

23. The method of claim 1, wherein providing a plurality of opportunities for members to participate in development of the knowledge community comprises providing an opportunity to lead a service learning project.

24. The method of claim 1, wherein providing a plurality of opportunities for members to participate in development of the knowledge community comprises providing an opportunity to lead an alumni event.

25. The method of claim 1, wherein providing a plurality of opportunities for members to participate in development of the knowledge community comprises providing an opportunity to lead a charitable living event.

26. The method of claim 1, wherein providing a plurality of opportunities for members to participate in development of the knowledge community comprises providing an opportunity publish articles and book reviews.

27. The method of claim 1, further comprising generating reports to track growth of the knowledge community and marketing of the academic services.

28. The method of claim 27, wherein the reports include a new students report indicating a number of new students who indicate that membership in the knowledge community is important to their choice of the academic institution.

29. The method of claim 27, wherein the reports include a student persistence report indicating a rate of student persistence to graduation relative to a base-line rate established prior to implementation of the knowledge community.

30. The method of claim 27, wherein the reports include a graduate re-enrollment report indicating a number of students who previously completed a certificate or degree program offered by the academic institution and re-enroll in a certificate or degree program offered by the academic institution.

31. The method of claim 27, wherein the reports include a graduates' children enrollment report indicating a number of new students who enroll in a certificate or degree program offered by the academic institution, wherein the new students' parents graduated from the academic institution.

32. The method of claim 27, wherein the reports include a publication report indicating a number of member articles and book reviews published within the knowledge community.

33. The method of claim 27, wherein the reports include a service participation report indicating a number of members who participate in service opportunities.

34. The method of claim 27, wherein the reports include an alumni participation report indicating a number of alumni of the academic institution who participate in the knowledge community and a number of alumni who co-produce virtual and face-to-face alumni sponsored events.

35. The method of claim 27, wherein the reports include an alumni contributions report indicating a number of members donors who did not contribute to or through the academic institution prior to implementation of the knowledge community and the total dollar value of charitable gifts made to or through the academic institution.

36. A system comprising:
a computer network; and
at least one server connected with the computer network, the server maintaining a plurality of web pages to provide academic services of an academic institution to members of a knowledge community through the network, the web pages comprising,
a community center, the community center comprising a plurality of web pages of general interest to all members of the knowledge community,
a plurality of discipline specific knowledge communities, each of the discipline specific knowledge communities comprising a plurality of web pages of specific interest to members of the knowledge community in targeted disciplines, and
a plurality of opportunities for a member of the knowledge community to participate in development of the knowledge community, the plurality of opportunities comprising a plurality of web pages through which the member may initiate activities.

37. The system of claim 36, wherein the community center comprises a member center, the member center comprising a searchable database of member information, the database accessible only by other members of the knowledge community.

38. The system of claim 37, wherein the member center further comprises a web page to enroll new members via an enrollment form.

39. The system of claim 37, wherein the member center further comprises a member participation profile generated based on member supplied information, wherein the member participation profile is stored in the searchable database of member information and provided to other members of the knowledge community if the member supplied information indicates that the member participation profile is public information.

40. The system of claim 37, wherein the member center further comprises a member web page generated based on information provided by the member via a member web page template form.

41. The system of claim 36, wherein the community center comprises an online information resource center, the online information resource center comprising a searchable database of articles from trade and academic periodicals, the database accessible only by other members of the knowledge community.

42. The system of claim 36, wherein the community center comprises an electronic journal (e-journal) center, the e-journal center comprising a searchable database of articles produced by members of the knowledge community, the database accessible only by other members of the knowledge community.

43. The system of claim 42, wherein the e-journal center further comprises a web page through which a member may submit an article or book review.

44. The system of claim 36, wherein the community center comprises a career center of career oriented information, career oriented information comprising career center news, searchable job announcements, searchable career oriented online expert led chats, searchable career oriented online discussion forums, and searchable information regarding career oriented virtual or face-to-face seminars, workshops, and conferences.

45. The system of claim 36, wherein the community center comprises a conference center, the conference center comprising news, searchable online expert led chats, searchable online discussion forums, and searchable information regarding virtual or face-to-face seminars, workshops, and conferences.

46. The system of claim 36, wherein the community center comprises an alumni center of alumni oriented information, the alumni oriented information comprising alumni news, searchable alumni online expert led chats, searchable alumni online discussion forums, and searchable information regarding alumni oriented virtual or face-to-face seminars, workshops, and conferences.

47. The system of claim 36, wherein the community center comprises a charitable living center of charity oriented information, the charity oriented information comprising service learning opportunities, nonprofit job and volunteer opportunities, searchable charity oriented news, searchable charity oriented online expert led chats, searchable charity oriented online discussion forums, and searchable information regarding charity oriented virtual or face-to-face seminars, workshops, and conferences.

48. The system of claim 36, wherein the plurality of discipline specific knowledge communities comprises discipline specific news, the discipline specific news comprising a searchable database of news and professional association news.

49. The system of claim 36, wherein the plurality of discipline specific knowledge communities comprises information regarding online and face-to-face discipline specific academic certificate programs.

50. The system of claim 36, wherein the plurality of discipline specific knowledge communities comprises information regarding online and face-to-face discipline specific academic degree programs.

51. The system of claim 36, wherein the plurality of discipline specific knowledge communities comprises searchable online discipline specific expert led chats.

52. The system of claim 36, wherein the plurality of discipline specific knowledge communities comprises searchable online discipline specific discussion forums.

53. The system of claim 36, wherein the plurality of discipline specific knowledge communities comprises searchable information regarding virtual and face-to-face meetings.

54. The system of claim 36, wherein the plurality of opportunities for members to participate in development of the knowledge community comprises an opportunity to lead a virtual or face-to-face meeting.

55. The system of claim 36, wherein the plurality of opportunities for members to participate in development of the knowledge community comprises an opportunity to lead an expert led online chat.

56. The system of claim 36, wherein the plurality of opportunities for members to participate in development of the knowledge community comprises an opportunity to lead an online discussion forum.

57. The system of claim 36, wherein the plurality of opportunities for members to participate in development of the knowledge community comprises an opportunity to submit news.

58. The system of claim 36, wherein the plurality of opportunities for members to participate in development of the knowledge community comprises an opportunity to lead a service learning project.

59. The system of claim 36, wherein the plurality of opportunities for members to participate in development of the knowledge community comprises an opportunity to lead an alumni event.

60. The system of claim 36, wherein the plurality of opportunities for members to participate in development of the knowledge community comprises an opportunity to lead a charitable living event.

61. The system of claim 36, wherein the plurality of opportunities for members to participate in development of the knowledge community comprises an opportunity publish articles and book reviews.

62. The system of claim 36, wherein the server generates reports to track growth of the knowledge community and marketing of the academic services.

63. The system of claim 62, wherein the reports include a new students report indicating a number of new students who indicate that membership in the knowledge community is important to their choice of the academic institution.

64. The system of claim 62, wherein the reports include a student persistence report indicating a rate of student persistence to graduation relative to a base-line rate established prior to implementation of the knowledge community.

65. The system of claim 62, wherein the reports include a graduate re-enrollment report indicating a number of students who previously completed a certificate or degree program offered by the academic institution and re-enroll in a certificate or degree program offered by the academic institution.

66. The system of claim 62, wherein the reports include a graduates' children enrollment report indicating a number of new students who enroll in a certificate or degree program offered by the academic institution, wherein the new students' parents graduated from the academic institution.

67. The system of claim 62, wherein the reports include a publication report indicating a number of member articles and book reviews published within the knowledge community.

68. The system of claim 62, wherein the reports include a service participation report indicating a number of members who participate in service opportunities.

69. The system of claim 62, wherein the reports include an alumni participation report indicating a number of alumni of the academic institution who participate in the knowledge community and a number of alumni who co-produce virtual and face-to-face alumni sponsored events.

70. The system of claim 62, wherein the reports include an alumni contributions report indicating a number of members donors who did not contribute to or through the academic institution prior to implementation of the knowledge community and the total dollar value of charitable gifts made to or through the academic institution.

71. A machine-readable medium having stored thereon data representing sequences of instructions, the sequences of instructions which, when executed by a processor, cause the processor to maintaining a plurality of web pages to provide academic services of an academic institution to members of a knowledge community through the network, the web pages comprising:
a community center, the community center comprising a plurality of web pages of general interest to all members of the knowledge community;
a plurality of discipline specific knowledge communities, each of the discipline specific knowledge communities comprising a plurality of web pages of specific interest to members of the knowledge community in targeted disciplines; and
a plurality of opportunities for a member of the knowledge community to participate in development of the knowledge community, the plurality of opportunities comprising a plurality of web pages through which the member may initiate activities.

72. The machine-readable medium of claim 71, wherein the community center comprises a member center, the member center comprising a searchable database of member information, the database accessible only by other members of the knowledge community.

73. The machine-readable medium of claim 72, wherein the member center further comprises a web page to enroll new members via an enrollment form.

74. The machine-readable medium of claim 72, wherein the member center further comprises a member participation profile generated based on member supplied information, wherein the member participation profile is stored in the searchable database of member information and provided to other members of the knowledge community if the member supplied information indicates that the member participation profile is public information.

75. The machine-readable medium of claim 72, wherein the member center further comprises a member web page generated based on information provided by the member via a member web page template form.

76. The machine-readable medium of claim 71, wherein the community center comprises an online information resource center, the online information resource center comprising a searchable database of articles from trade and academic periodicals, the database accessible only by other members of the knowledge community.

77. The machine-readable medium of claim 71, wherein the community center comprises an electronic journal (e-journal) center, the e-journal center comprising a searchable database of articles produced by members of the knowledge community, the database accessible only by other members of the knowledge community.

78. The machine-readable medium of claim 77, wherein the e-journal center further comprises a web page through which a member may submit an article or book review.

79. The machine-readable medium of claim 71, wherein the community center comprises a career center of career oriented information, career oriented information comprising career center news, searchable job announcements, searchable career oriented online expert led chats, searchable career oriented online discussion forums, and searchable information regarding career oriented virtual or face-to-face seminars, workshops, and conferences.

80. The machine-readable medium of claim 71, wherein the community center comprises a conference center, the conference center comprising news, searchable online expert led chats, searchable online discussion forums, and searchable information regarding virtual or face-to-face seminars, workshops, and conferences.

81. The machine-readable medium of claim 71, wherein the community center comprises an alumni center of alumni oriented information, the alumni oriented information comprising alumni news, searchable alumni online expert led chats, searchable alumni online discussion forums, and searchable information regarding alumni oriented virtual or face-to-face seminars, workshops, and conferences.

82. The machine-readable medium of claim 71, wherein the community center comprises a charitable living center of charity oriented information, the charity oriented information comprising service learning opportunities, nonprofit job and volunteer opportunities, searchable charity oriented news, searchable charity oriented online expert led chats, searchable charity oriented online discussion forums, and searchable information regarding charity oriented virtual or face-to-face seminars, workshops, and conferences.

83. The machine-readable medium of claim 71, wherein the plurality of discipline specific knowledge communities comprises discipline specific news, the discipline specific news comprising a searchable database of news and professional association news.

84. The machine-readable medium of claim 71, wherein the plurality of discipline specific knowledge communities comprises information regarding online and face-to-face discipline specific academic certificate programs.

85. The machine-readable medium of claim 71, wherein the plurality of discipline specific knowledge communities comprises information regarding online and face-to-face discipline specific academic degree programs.

86. The machine-readable medium of claim 71, wherein the plurality of discipline specific knowledge communities comprises searchable online discipline specific expert led chats.

87. The machine-readable medium of claim 71, wherein the plurality of discipline specific knowledge communities comprises searchable online discipline specific discussion forums.

88. The machine-readable medium of claim 71, wherein the plurality of discipline specific knowledge communities comprises searchable information regarding virtual and face-to-face meetings.

89. The machine-readable medium of claim 71, wherein the plurality of opportunities for members to participate in development of the knowledge community comprises an opportunity to lead a virtual or face-to-face meeting.

90. The machine-readable medium of claim 71, wherein the plurality of opportunities for members to participate in development of the knowledge community comprises an opportunity to lead an expert led online chat.

91. The machine-readable medium of claim 71, wherein the plurality of opportunities for members to participate in development of the knowledge community comprises an opportunity to lead an online discussion forum.

92. The machine-readable medium of claim 71, wherein the plurality of opportunities for members to participate in development of the knowledge community comprises an opportunity to submit news.

93. The machine-readable medium of claim 71, wherein the plurality of opportunities for members to participate in development of the knowledge community comprises an opportunity to lead a service learning project.

94. The machine-readable medium of claim 71, wherein the plurality of opportunities for members to participate in development of the knowledge community comprises an opportunity to lead an alumni event.

95. The machine-readable medium of claim 71, wherein the plurality of opportunities for members to participate in development of the knowledge community comprises an opportunity to lead a charitable living event.

96. The machine-readable medium of claim 71, wherein the plurality of opportunities for members to participate in development of the knowledge community comprises an opportunity publish articles and book reviews.

97. The machine-readable medium of claim 71, wherein the series of instructions further cause the server to generate reports to track growth of the knowledge community and marketing of the academic services.

98. The machine-readable medium of claim 97, wherein the reports include a new students report indicating a number of new students who indicate that membership in the knowledge community is important to their choice of the academic institution.

99. The machine-readable medium of claim 97, wherein the reports include a student persistence report indicating a rate of student persistence to graduation relative to a base-line rate established prior to implementation of the knowledge community.

100. The machine-readable medium of claim 97, wherein the reports include a graduate re-enrollment report indicating a number of students who previously completed a certificate or degree program offered by the academic institution and re-enroll in a certificate or degree program offered by the academic institution.

101. The machine-readable medium of claim 97, wherein the reports include a graduates' children enrollment report indicating a number of new students who enroll in a certificate or degree program offered by the academic institution, wherein the new students' parents graduated from the academic institution.

102. The machine-readable medium of claim 97, wherein the reports include a publication report indicating a number of member articles and book reviews published within the knowledge community.

103. The machine-readable medium of claim 97, wherein the reports include a service participation report indicating a number of members who participate in service opportunities.

104. The machine-readable medium of claim 97, wherein the reports include an alumni participation report indicating a number of alumni of the academic institution who participate in the knowledge community and a number of alumni who co-produce virtual and face-to-face alumni sponsored events.

105. The machine-readable medium of claim 97, wherein the reports include an alumni contributions report indicating a number of members donors who did not contribute to or through the academic institution prior to implementation of the knowledge community and the total dollar value of charitable gifts made to or through the academic institution.
